(19) United States
(12) Patent Application Publication
(10) Pub. No.: US 2007/0255889 A1
(43) Pub. Date: Nov. 1, 2007

(54) Non-volatile memory device and method of operating the device

(76) Inventors: Yoav Yogev, Maskeret-Batia (IL); Eli Lusky, Tel Aviv (IL)

Correspondence Address: EMPK & SHILOH, LLP, 116 JOHN ST,, SUITE 1201, NEW YORK, NY, 10038, US

(21) Appl. No.: 11/723,836

(22) Filed: Mar. 22, 2007

Related U.S. Application Data
(60) Provisional application No. 60/784,463, filed on Mar. 22, 2006.

(51) Int. Cl. G06F 12/00

(52) U.S. Cl. 711/103

(57) ABSTRACT

Disclosed is a non-volatile memory device and methods of operating the device. According to some embodiments of the disclosed invention, there is provided a method and apparatus for disturb wear leveling where data may be moved from a first sector to another sector.

### CROSS REFERENCE TO RELATED APPLICATIONS

This application claims the benefit of U.S. Provisional Application No. 60/784,463, filed Mar. 22, 2006, the entire disclosure of which is incorporated herein by reference.

### BACKGROUND

Exemplary embodiments disclosed herein pertain to digital memory used in digital electronic devices. More particularly, exemplary embodiments disclosed herein pertain to flash memory devices.

Computers use RAM (Random Access Memory) to hold the program code and data during computation. A defining characteristic of RAM is that all memory locations can be accessed at almost the same speed. Most other technologies have inherent delays for reading a particular bit or byte. Adding more RAM is an easy way to increase system performance.

Early main memory systems built from vacuum tubes behaved much like modern RAM, except the devices failed frequently. Core memory, which used wires attached to small ferrite electromagnetic cores, also had roughly equal access time (the term “core” is still used by some programmers to describe the RAM main memory of a computer). The basic concepts of tube and core memory are used in modern RAM implemented with integrated circuits.

Alternative primary storage mechanisms usually involved a non-uniform delay for memory access. Delay line memory used a sequence of sound wave pulses in mercury-filled tubes to hold a series of bits. Drum memory acted much like the modern hard disk, storing data magnetically in continuous circular bands.

Many types of RAM are volatile, which means that unlike some other forms of computer storage such as disk storage and tape storage, they lose all data when the computer is powered down. Modern RAM generally stores a bit of data as either a charge in a capacitor, as in “dynamic RAM,”, or the state of a flip-flop, as in “static RAM”.

Non-Volatile Random Access Memory (NVRAM) is a type of computer memory chip which does not lose its information when power is turned off. NVRAM is mostly used in computer systems, routers and other electronic devices to store settings which must survive a power cycle (like number of disks and memory configuration). One example is the magnetic core memory that was used in the 1950s and 1960s.

The many types of NVRAM under development are based on various technologies, such as carbon nanotube technology, magnetic RAM (MRAM) based on the magnetic tunnel effect, Ovonic Unified Memory based on phase-change technology, and FeRAM based on the ferroelectric effect. Today, most NVRAM is Flash memory, which is used in cell phones, PDAs, portable MP3 players, cameras, digital recording devices, personal mass storage “dongles”, and many others, often referred to simply as NVM (Non-Volatile Memory).

Flash memory is non-volatile, which means that it does not need power to maintain the information stored in the chip. In addition, flash memory offers fast read access times (though not as fast as volatile DRAM memory used for main memory in PCs) and better shock resistance than hard disks. These characteristics explain the popularity of flash memory for NVM applications such as storage on battery-powered devices.

One type of flash memory stores information in an array of floating gate transistors called “cells”, each of which traditionally stores one bit of information. Another, newer type of flash memory is trapping, which uses a non-conductive layer, such as an oxide-nitride-oxide sandwich to trap electrons. One implementation of ONO trapping is NROM which can store 2 or more physical bits in one cell by varying the number of electrons placed on the cell. These devices are sometimes referred to as multi-level cell devices. Where applicable, descriptions involving NROM are intended specifically to include related oxide-nitride technologies, including SONOS (Silicon-Oxide-Nitride-Oxide-Silicon), MNOS (Metal-Nitride-Oxide-Silicon), MONOS (Metal-Oxide-Nitride-Oxide-Silicon) and the like used for NVM devices Further description of NROM and related technologies may be found at “Non Volatile Memory Technology”, 2005 published by Saifun Semiconductor and materials presented at and through http://siliconnexus.com,
“Design Considerations in Scaled SONOS Nonvolatile Memory Devices” found at: http://klabs.org/richcontent/MemoryContent/nvmt_symp/nvmts_{—}2000/presentations/bu_white_sonos_lehigh_univ.pdf,
“SONOS Nonvolatile Semiconductor Memories for Space and Military Applications” found at http://klabs.org/richcontent/MemoryContent/nvmt_symp/nvmts_{—}2000/papers/adams_d.pdf,
“Philips Research—Technologies—Embedded Nonvolatile Memories” found at: http://www.research.philips.com/technologies/ics/nvmemories/index.html, and
“Semiconductor Memory: Non-Volatile Memory (NVM)” found at: http://www.ece.nus.edu.sq/stfpaqe/elezhucx/myweb/NVM.pdf,
all of which are incorporated by reference herein in their entirety.

NOR-based flash has long erase and write times, but has a full address/data (memory) interface that allows random access to any location. This makes it suitable for storage of program code that needs to be infrequently updated, such as a computer's BIOS (Basic Input-Output Software) or the firmware of set-top boxes. Most commercially available Flash is rated with an endurance of usually between 10,000 to 1,000,000 or more erase cycles. NOR-based (not OR) flash was the basis of early flash-based removable media; Compact Flash was originally based on it, though later cards moved to the less costly NAND (not AND) type flash.

In NOR flash, each cell commonly looks similar to a standard MOSFET (Metal Oxide Semiconductor Field Effect Transistor), except that it has more than one gate, usually two gates. One gate is the control gate (CG) like in other MOS transistors, but the second is a floating gate (FG) that is usually insulated all around, as by an oxide (such as silicon oxide)layer. The FG is usually located between the CG and the substrate. Because the FG is isolated by its insulating oxide layer, any electrons placed on the FG remain on the gate and thus store the information.

When electrons are on the FG, they modify (partially cancel out) the electric field coming from the CG, which modifies the threshold voltage (V₁) of the cell. Thus, when the cell is “read” by placing a specific voltage on the CG, electrical current will either flow or not flow, depending on the V₁ of the cell, which is controlled by the number of electrons on the FG.

This presence or absence of current may be sensed and translated into Binary digiTs (bits) or 1's and 0's, representing the stored data. In a multi-level cell device, which may store more than 1 bit of information per cell, the amount of current flow may be sensed, rather than simply detecting presence or absence of current, in order to determine the number of electrons stored on the FG.

A NOR flash cell is usually programmed (set to a specified data value) by initiating electrons flowing from the source to the drain, then a large voltage may be placed on the CG to provide a strong enough electric field to draw (attract) the electrons up onto the FG, a process called hot-electron injection.

To erase (which is usually done by a reset to all 1's, in preparation for reprogramming) a NOR flash cell, a large voltage differential is placed between the CG and source, which pulls the electrons off through what is currently believed to be quantum tunneling. In single-voltage devices (virtually all chips available today), this high voltage may be generated by an on-chip charge pump.

Most modern NOR flash memory components are divided into erase segments, usually called either blocks or sectors. All of the memory cells in a block must be erased at the same time. NOR programming, however, can generally be performed one byte or word at a time.

Low-level access to a physical flash memory, as by device driver software is different from accessing common memories. Whereas a common RAM will simply respond to read and write operations by returning the contents or altering them immediately, flash memories usually need special considerations, especially when used as program memory akin to a read-only memory (ROM).

While reading data can be performed on individual addresses on NOR memories unlocking (making available for erase or write), erasing and writing operations are performed block-wise on flash memories. A typical block size may be for example: 64 Kb, 128 Kb, 256 Kb,1 Mb or more.

The read-only mode of NOR memories is similar to reading from a common memory, provided an address and data bus is mapped correctly, so NOR flash memory is much like other address-mapped memory. NOR flash memories can be used as execute-in-place memory, meaning it behaves as a ROM memory mapped to a certain address.

When unlocking, erasing or writing NOR memories, special commands are written to the first page of the mapped memory. These commands are defined as the common flash interface (one common version is defined by Intel Corporation) and the flash circuit may provide a list of all essentially available commands to the physical driver.

NAND Flash usually uses tunnel injection for writing and tunnel release for erasing. NAND flash memory forms the core of the removable USB (Universal Serial Bus)interface storage devices known as keydrives, disk-on-key or thumb memory devices, as well as other memory devices—such as those used in digital cameras, digital recording devices, digital audio devices and the like.

NAND flash memories cannot provide execute-in-place due to their different construction principles. These memories are accessed much like block devices such as hard disks or memory cards. When executing software from NAND memories, virtual memory strategies are usually used: memory contents must first be paged into memory-mapped RAM and executed there, making the presence of a memory management unit (MMU) on the system absolutely necessary.

For this reason some systems will use a combination of NOR and NAND memories, where the NOR memory is used as software ROM (Read Only Memory) and the NAND memory is partitioned, as with a file system, and used as a random access storage area.

Because of the particular characteristics of flash memory, it is best used with specifically designed file systems which spread writes over the media and deal with the long erase times of NOR flash blocks. The basic concept behind flash file systems is that when the flash store is to be updated, the file system will write a new copy of the changed data over to a fresh block, remap the file pointers, then erase the old block later when it has time.

One limitation of flash memory is that although it can be read or programmed a byte or a word at a time in a random access fashion, it should be erased a “block” at a time. Starting with a freshly erased block, any byte within that block can be programmed. However, once a byte has been programmed, it cannot be changed again until the entire block is erased. In other words, most flash memory (specifically NOR flash) offers random-access read and programming operations, but does not offer random-access rewrite or erase operations. There are exceptions; partial programming and very small blocks may permit essentially random access write, re-write and erase operations.

As compared to a hard disk drive, a further limitation of most Flash memory is that flash memory has a nominally limited number of erase-write cycles so that care has should be taken not to over-write or erase the same section too often, or one portion of a Flash chip will “wear out” or fail before the remainder of the chip—causing early obsolescence. This may happen most commonly when moving hard-drive based (type) applications, such as operating systems, to flash-memory based devices such as CompactFlash. This effect may be partially offset by some chip firmware or file system drivers which may count the writes and dynamically re-map the blocks in order to spread the write operations between various sectors, or by write verification and remapping to spare sectors in case of write failure. In a related issue, commonly referred to as disturb wear (which is more fully described in Adtron—Smart Storage, Smart People, which can be found at http://www.adtron.com/products/flash-disk.html; Examining NAND Flash Alternatives for Mobiles: Part 1, which can be found at http://www.commsdesign.com/article/printableArticle.jhtml?articleID=16502199;
and Examining NAND Flash Alternatives for Mobiles: Part 2, which can be found at http://www.commsdesign.com/article/printableArticle.jhtml?article ID=16502190;
each incorporated herein by reference in their entirety) errors may be produced or encountered when read, write, erase, or other operations performed on one Flash block affect the integrity of other Flash blocks in their vicinity. Various Error Correction Code (ECC) algorithms may be used to correct disturb errors, such as by rewriting the data to the existing Flash block or to a different available Flash block, or the like.

The prior art does not teach effective and efficient solutions to the problems arising from erasure of nearby sectors, which are considered to be cumulative and eventually result in data loss.

These and other limitations of known art will become apparent to those of skill in the art upon a reading of the following descriptions and a study of the several figures of the drawing.

### SUMMARY

Certain exemplary embodiments provide a method for managing the storage of data in a memory device by determining when a given sector of storage has been subjected to a prescribed amount of wear, and moving the data contained therein to another location, preferably one of minimal wear.

Certain embodiments monitor usage of a given sector, and maintain information about usage in that sector, for example in a worn sector table, as well as sectors that are related to that sector.

In certain exemplary embodiments, a mapping table is used to maintain a mapping between logical and physical addresses, so that the integrity of references into the storage of the device from attached devices is maintained, even though the data associated with those addresses is moved from one place to another in the device's physical address space. The mapping table is updated when such data moves occur.

In certain embodiments, the storage of the device is arranged in one or more grids (or physical sectors) of rows and columns of sectors. Preferably, information pertaining to the wear of each sector is maintained in a data structure that allows for random access.

Certain embodiments maintain a list of sectors that have reached a high level of wear for which the data should soon be moved, for example a worn sector table, accompanied by an ongoing operation which moves the sectors as it clears the entries in the list.

Certain embodiments maintain a number which indicates the lowest number of times any sector in the device has been “programmed.” Optionally, this information may be maintained at varying levels of granularity. Such information is used to aid in locating a new sector to receive the data in a sector that has reached a high level of wear; by comparing the count for a given sector to the minimum, it is possible to quickly determine whether or not the given sector is among the least worn.

This rapid determination of the “freshness” of a sector may be used during the wear balancing operation that processes the aforementioned list of highly worn sectors, thus if there are one or more highly worn sectors on the list, this methodology determines to move the data contained in those sectors, and if there are no highly worn sectors on the list, it determines that nothing is to be done. This has the overall effect of homogenizing or evening wear throughout the device's storage.

In certain embodiments, the device includes RAM used to maintain the various data structures needed for the wear balancing operation, as well as other functions of the device. Also included is a control state machine which may be embodied as a microcontroller or the like, or as discreet logic or the like.

According to certain embodiments, the control state machine manages communication with outside devices, as well as maintaining the data structures in RAM, and the data in storage. In one embodiment, the control state machine generally carries out the wear balancing operations described herein, including maintaining the aforementioned information relating to wear (such as, by way of non-limiting example, counts for each sector of erasures in related sectors on the same row or column), the logical/physical map, and other options.

In one embodiment, the control state machine is disposed to make a determination of when to move a sector, and to maintain the logical/physical map, along with the various counters which maintain the minimum program count, and the like.

One advantage of this novel technology, especially as shown by these exemplary embodiments, is to help extend the useful life of the storage device. Another advantage is to improve the overall reliability of the device.

According to some embodiments of the present invention, there is provided a non-volatile memory device. According to some embodiments of the present invention, said device may comprise a controller adapted to select a destination memory sector to which to write data based on a wear leveling algorithm.

According to some embodiments of the present invention, said device may further include count logic that may detect usage of the memory sectors and may update a usage count accordingly.

According to some embodiments of the present invention, said controller logic may also include disturb logic that may determine if a memory sector has been subjected to conditions which would imply excessive wear and may update a disturb list accordingly.

According to some embodiments of the present invention, said controller may perform a wear balancing operation. According to some embodiments of the present invention, the wear balancing operation may be performed at each write operation. According to some alternative embodiments of the present invention, the wear balancing operation may be performed whenever the controller detects that such an operation may be required to maintain the integrity of data stored on the device.

According to some embodiments of the present invention, the wear balancing operation may include moving data from memory sectors listed in the disturb list.

According to some embodiments of the present invention, the controller may update a logical/physical mapping table corresponding to memory sector moves performed during the wear balancing operation.

According to some embodiments of the present invention, the controller may include a minimum program counter logic, and may use it to determine a least used memory sector.

According to some embodiments of the present invention, the minimum program counter may store an address of said least used memory sector.

According to some embodiments of the present invention, the controller may use data from said minimum program counter during a wear balancing operation.

According to some embodiments of the present invention, the controller may use said minimum program counter in selecting a destination memory sector to which data from a worn sector is to be copied.

These and other embodiments and advantages of the novel materials and other features disclosed herein will become apparent to those of skill in the art upon a reading of the following descriptions and a study of the several figures of the drawing.

### BRIEF DESCRIPTION OF THE DRAWINGS

Several exemplary embodiments will now be described with reference to the drawings, wherein like components are provided with like reference numerals. The exemplary embodiments are intended to illustrate, but not to limit, the invention. The drawings include the following figures:

FIG. 1 is a block diagram showing an exemplary processor coupled to an exemplary flash memory device which includes a control state machine, RAM to contain data management data structures, and a flash memory array composed of one or more physical sectors;

FIG. 2 is an illustration of the structure of an exemplary physical sector of FIG. 1 in greater detail, depicting a grid of rows and columns of erase sectors;

FIG. 3 is an illustration of an exemplary support data structure which contains a P-sector array, a logical/physical map, a disturb list, and a MIN program counter;

FIG. 4 is an illustration of an exemplary P-sector array of FIG. 3 in greater detail wherein each element of the P-sector array is a P-sector array element;

FIG. 5 is an illustration of an exemplary P-sector array element of FIG. 4 in greater detail wherein the P-sector array element contains an E-sector array, and a MIN program counter;

FIG. 6 is an illustration of an exemplary E-sector array of FIG. 5 in greater detail which is comprised of a grid of rows and columns of E-sector array elements;

FIG. 7 is an illustration of an exemplary E-sector array element of FIG. 6 in greater detail which contains a program counter, a bit line disturb counter, a word line disturb counter, and an erase status;

FIG. 8 is an illustration of an exemplary logical/physical map of FIG. 3 shown in greater detail which contains a logical to physical array and a physical to logical array;

FIG. 9 is an illustration of an exemplary disturb list of FIG. 3 shown in greater detail wherein a shown entry is a reference to an erase sector that has been subjected to a high degree of wear;

FIG. 10 is a flow diagram of an exemplary operation to program a page;

FIG. 11 is a flow diagram of an exemplary operation to handle a disturb list of FIG. 10 shown in greater detail which balances [YY] disturb by moving data from highly disturbed erase sectors to non disturbed erase sectors;

FIG. 12 is a flow diagram of an exemplary operation to allocate a block of FIG. 10 shown in greater detail which locates an erase sector of minimal wear, erases it, and maps it to a specified address;

FIG. 13 is a flow diagram of an exemplary operation to find a free block of minimal wear of FIG. 12 shown in greater detail which ensures that at least one free block is maintained in each physical sector, and that logically adjacent erase sectors do not reside on the same physical sector;

FIG. 14 is a flow diagram of an exemplary operation to erase an erase sector of FIG. 12 shown in greater detail which maintains disturb counters pertaining to the erase sector and other nearby erase sectors in the same row or column, queuing for refresh any affected erase sector that now exceeds one or more disturb thresholds, and running a wear leveling operation if conditions are appropriate;

FIG. 15 is a flow diagram of an exemplary wear leveling operation of FIG. 14 in greater detail which, for a given erase sector, finds another minimally worn erase sector, excluding ones that reside on physical sectors containing logically adjacent erase sectors, copies the data from the found erase sector to the given one, remaps logical/physical map of FIG. 3 to reflect the data copy operation, and erases the found erase sector;

FIG. 16 is a flow diagram of an exemplary logical/physical mapping operation of FIG. 15 shown in greater detail.

### DETAILED DESCRIPTION OF EXEMPLARY EMBODIMENTS

It should be noted that the foregoing descriptions and corresponding figures are given by way of example. Flash memory arrays and associated circuitry vary in structure and tailored implementation is required.

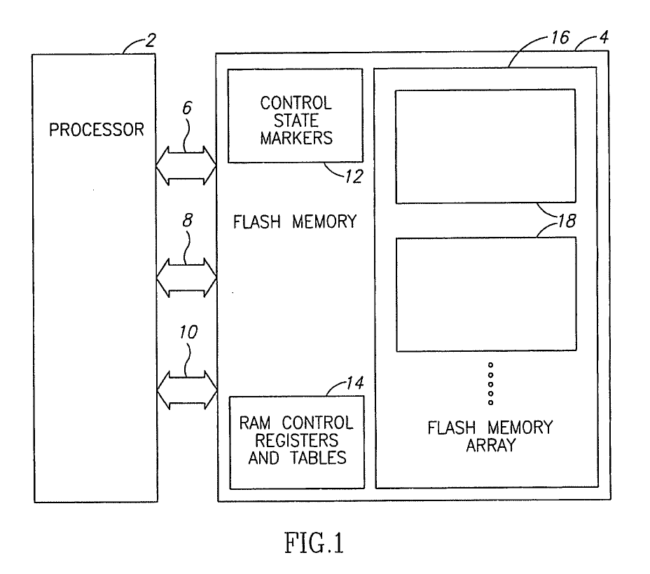

FIG. 1 is a block diagram depicting an exemplary embodiment wherein a processor 2 is coupled to a flash memory device 4. Processor 2 is connected to flash memory device 4 by address bus 6, control bus 8 and data bus 10. In practice, address bus 6, control bus 8 and data bus 10 often comprise a single multi-purpose bus. Disposed within flash memory device 4 is a control state machine 12 which may be comprised of discreet logic or a microcontroller. Also included within flash memory device 4 are RAM control registers and table 14. Also disposed within flash memory device 4 is flash memory array 16. Flash memory array 16 is composed of a plurality of physical sectors 18 which serve as the main storage for flash memory device 4.

In an exemplary embodiment, processor 2 communicates with flash memory device 4 via NAND Interface address bus 6, control bus 8 and data bus 10. In one embodiment, processor 2 has direct access to RAM control registers and tables 14. In another embodiment, processor 2 accesses RAM control registers and tables 14 through the via media of control state machine 12. Control state machine 12 is generally responsible for enforcing the protocol between processor 2 and flash memory device 4 as well as orchestrating access to RAM control registers and tables 14 and flash memory array 16. Control state machine 12 utilizes RAM control registers and tables 14 to keep track of information needed during the various operations performed on flash memory array 16. RAM control registers and tables 14 contains transient information which is needed to support and manage the 10 operations performed to flash memory array 16.

Since RAM control registers and table 14 is comprised, in an exemplary embodiment, of volatile memory, it is necessary to have a backing store for any information for which persistence is required.

In an exemplary embodiment, said persistent information is stored within a reserved area of flash memory array 16. During normal operation of processor 2, it is generally necessary to perform read and write operations to the data storage provided by flash memory device 4. When performing a read operation, processor 2 transmits address information on address bus 6 and control information on control bus 8 which is received by control state machine 12. Control state machine 12 accesses RAM control registers and tables 14 to determine the physical sector 18 associated with the address information on address bus 6. Once it is determined which physical sector 18 is being accessed, additional address information on address bus 6 is used to access the specific portion of physical sector 18 which is being requested. The data is then returned on data bus 10 to processor 2.

A write operation performed by processor 2 would be carried out by placing address information on address bus 6 as well as control information on control bus 8 and data on data bus 10. Control state machine 12 receives the control information on control bus 8 indicating that a write operation is being performed. Control state machine 12 then accesses the address bus 6 to determine which portion of the flash memory array 16 is being accessed. This address information is used to access RAM control registers and tables 14 and map the address on address bus 6 to a physical address within flash memory array 16. In some cases, this will involve allocation of physical blocks within flash memory array 16, thus altering the data structures contained within RAM control registers and tables 14. Control state machine 12 controls the data transfer of the data from data bus 10 into flash memory array 16, and more specifically, into the physical sector 18 to which the address on address bus 6 maps.

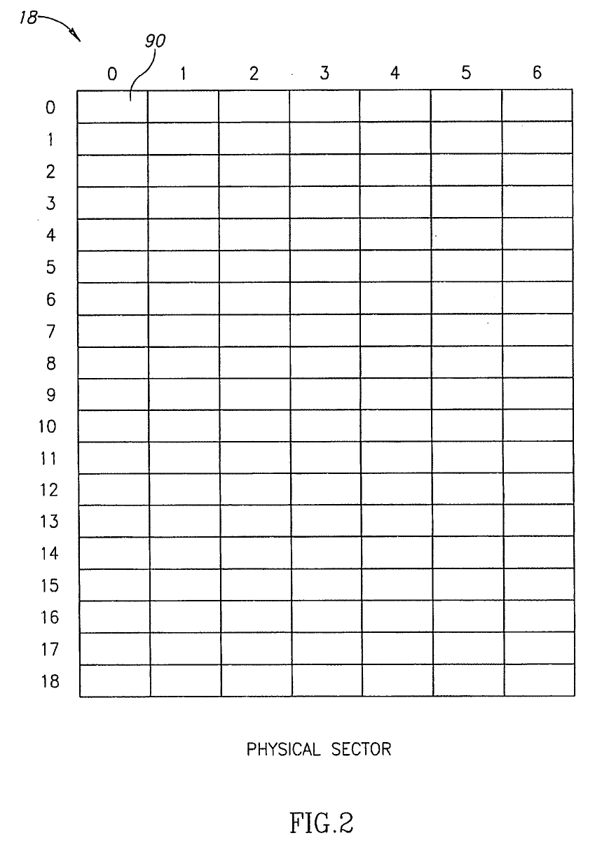

FIG. 2 shows an exemplary physical sector 18 of FIG. 1 in greater detail Physical sector 18 is comprised of a grid of erase sectors 20.

In an exemplary embodiment, the erase sectors 20 are arranged in a grid with 19 rows and 6 columns. Each erase sector 20 constitutes a portion of flash memory which, when it is erased, must be treated as a single unit. This is why it is called an erase sector 20. When the address on address bus 6 is translated through RAM control registers and tables 14 by control state machine 12, a physical address is obtained. The low order bits of the physical address specify which erase sector 20 within the physical sector 18 is to be accessed. The low order bits also specify what portion of erase sector 20 is to be accessed. When one writes to or erases an erase sector 20, one activates certain bit lines 24 (not shown) which run vertically through physical sector 18 and word lines 26 which run horizontally through physical sector 18. Thus, the various data storage elements of physical sector 18 are electrically connected to one another by these vertical and horizontal connections.

When erasing an erase sector 20, the voltages on bit lines 24 and word lines 26 are set to a level appropriate for erasure of the specific erase sector 20 that is being erased. This has the effect of erasing the entire erase sector 20 but also has a side effect of “disturbing” the other data within physical sector 18 that it is connected to by bit lines 24 and word lines 26 (not shown). The effect of the disturbances is cumulative such that over time, a sufficient number of disturb operations can result in corrupted data in other erase sectors 20 within the same physical sector 18. The exact number of disturb operations that will cause this effect varies within respect to the specific technology used in flash memory device 4. These numbers can be derived empirically through the use of a test program which exercises one or more erase sectors 20 within a physical sector 18 and, then, verifies all the data within physical sector 18.

It should be noted that the effect of a disturb is different vertically than it is horizontally and also varies with respect to erase operations as opposed to write operations. For example, an erase sector 20 can sustain approximately 2,000 disturb operations caused by accesses to other erase sectors to which it is horizontally connected via the word lines. The vertical bit line disturb operations are different; an erase sector 20 can sustain in this example approximately 180 disturb operations caused by accesses to other erase sectors 20 to which it is connected vertically via bit lines 24.

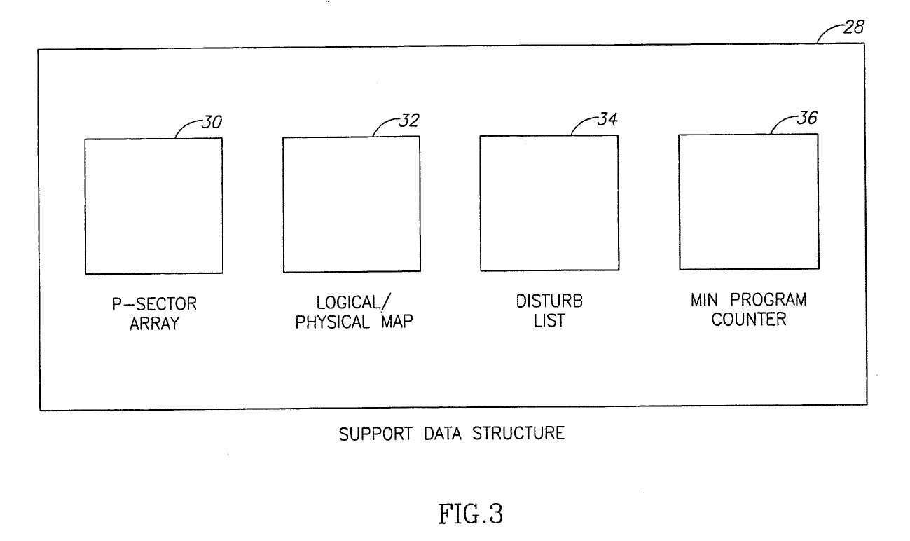

FIG. 3 shows an exemplary support data structure 28 which is used when accessing flash memory array 16. Support data structure 28 contains various tables and counters which are used to keep an accounting of the mapping between logical and physical addresses, as well as an accounting of the disturb operations that have been performed on each erase sector 20, etc. Support data structure 28 is comprised of P-sector array 30, logical/physical map 32, disturb list 34, and MIN program counter 36. P-sector array 30 contains information about the physical sectors of flash memory array 16. It contains detailed information about each physical sector 18 and the storage elements contained therein. It is used to keep track of how many disturb operations have been performed as well as count the number of times that a particular erase sector has been programmed or written.

Logical/physical map 32 contains arrays which allow for rapid conversion of a logical address to a physical address and vice versa. In an exemplary embodiment, the logical/physical map 32 allows a mapping which is at the granularity of erase sector 20. That is logical/physical map 32 can identify the physical location of a specified block of memory which is equal or similar in size to erase sector 20. Logical/physical map 32 also contains information which allows the translation of a physical address into a logical address.

Disturb list 34 contains a list of erase sectors 20 which have exceeded preset thresholds in terms of the number of disturbs that have occurred. Disturb list 34 is essentially used to keep track of those erase sectors 20 that are in danger of corruption.

MIN program counter 36 contains an integer which indicates the number of times an erase sector 20 has been programmed. This integer applies to the entire flash memory array 16. Initially, MIN program counter 36 is set to zero. Its value changes as flash memory device 4 is used. When MIN program counter 36 takes on a value of one, it means that every single erase sector 20 within flash memory array 16 has been programmed at least once. Similarly, when MIN program counter 36 reaches the value of two, it means that each and every erase sector 20 within flash memory array 16 has been programmed at least twice. MIN program counter 36 allows one to detect which erase sectors 20 have seen the least amount of reuse. For example, if it is known that a particular erase sector has been programmed three times, and MIN program counter 36 has a current value of three, then, it is clear that the erase sector 20 in question is among the “freshest” erase sectors 20 available.

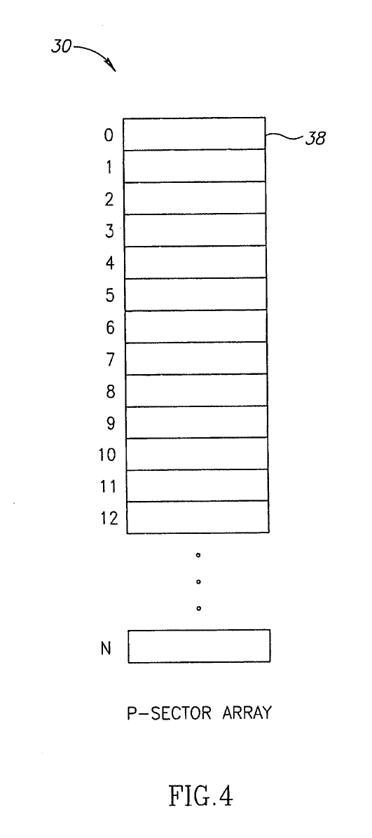

FIG. 4 shows an exemplary P-sector array 30 of FIG. 3 in greater detail. P-sector array 30 contains a number of P-sector array elements 38 which is equal to the number of physical sectors 18 that are present in flash memory array 16. Each P-sector array element contains information relating to the management of the corresponding physical sector 18.

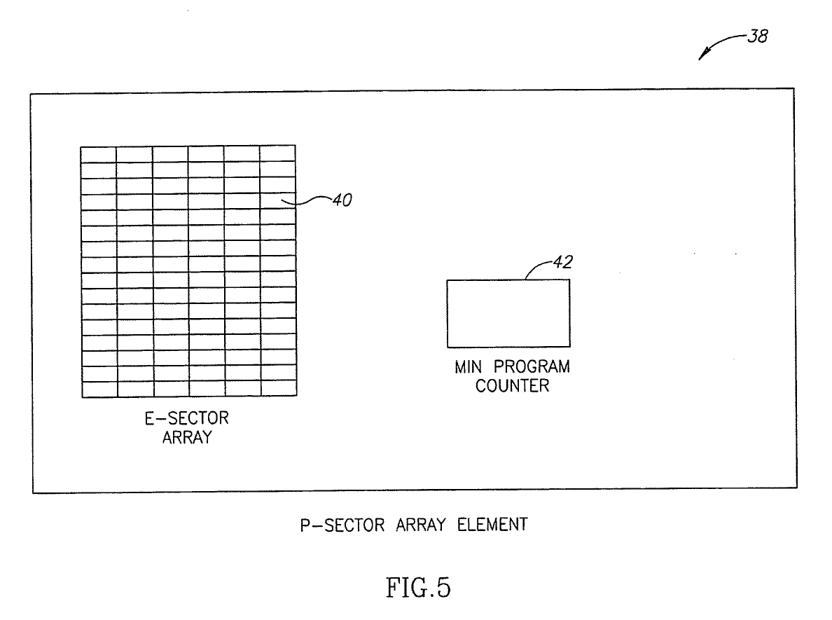

FIG. 5 shows a P-sector array element 38 of FIG. 4 in greater detail. A P-sector array element 38 contains an E-sector array 40 as well as a MIN program counter 42. E-sector array 40 and MIN program counter 42 pertain to a specific physical sector 18 within flash memory array 16. E-sector array 40 contains detailed information relating to the erase sectors 20 within the corresponding physical sector 18. MIN program counter 42 contains an integer which indicates the lowest number of program operations to be found among the erase sectors 20 of the corresponding physical sector 18.

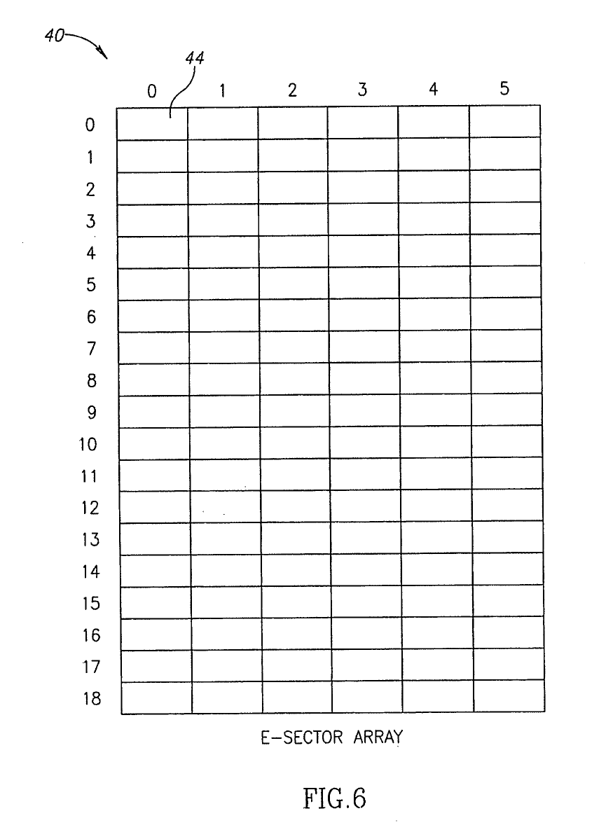

FIG. 6 shows an exemplary E-sector array 40 of FIG. 5 in greater detail. E-sector array 40 is comprised of a grid of E-sector array elements 44 which matches the physical structure of an array in erase sector 20. As with erase sector 20, there are 19 rows and 6 columns in an exemplary embodiment. Each E-sector array element 44 contains information pertaining to a specific erase sector 20 within flash memory array 16.

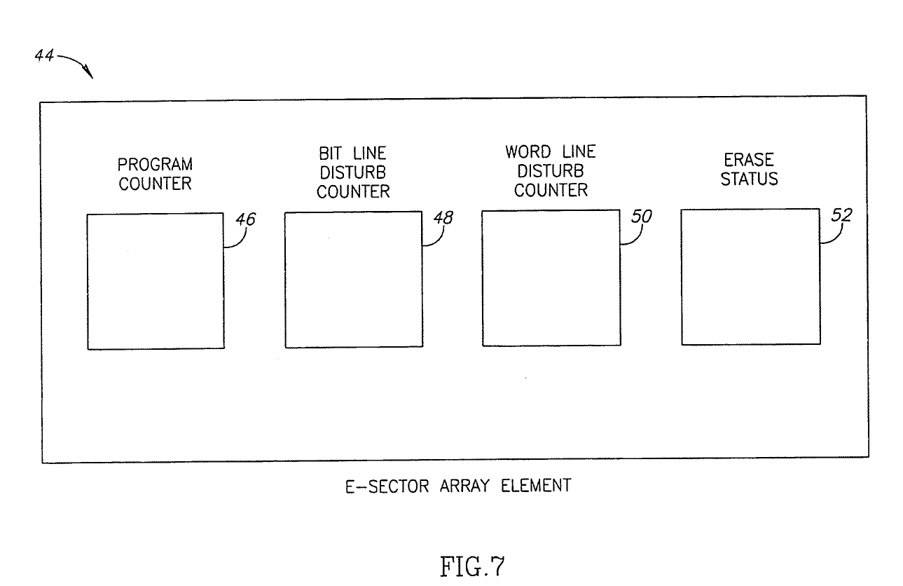

FIG. 7 shows an exemplary E-sector array element 44 of FIG. 6 in greater detail. E-sector array element 44 contains a program counter 46, a bit line disturb counter 48, a word line disturb counter 50, and erase status 52. Program counter 46 contains an integer which indicates the number of times the corresponding erase sector 20 has been programmed. Bit line disturb counter 48 contains an integer that indicate the number of disturb operations that have occurred to erase sector 20 caused by other erase sectors 20 to which it is connected via bit lines 24 within the same physical sector 18. Word line disturb counter 50 contains an integer that indicates the number of disturb operations that have occurred to erase sector 20 that have been caused by other erase sectors 20 to which it is connected via word lines 26 within the same physical sector 18. Erase status 52 contains a Boolean value which indicates whether or not the corresponding erase sector 20 is a freshly erased erase sector 20.

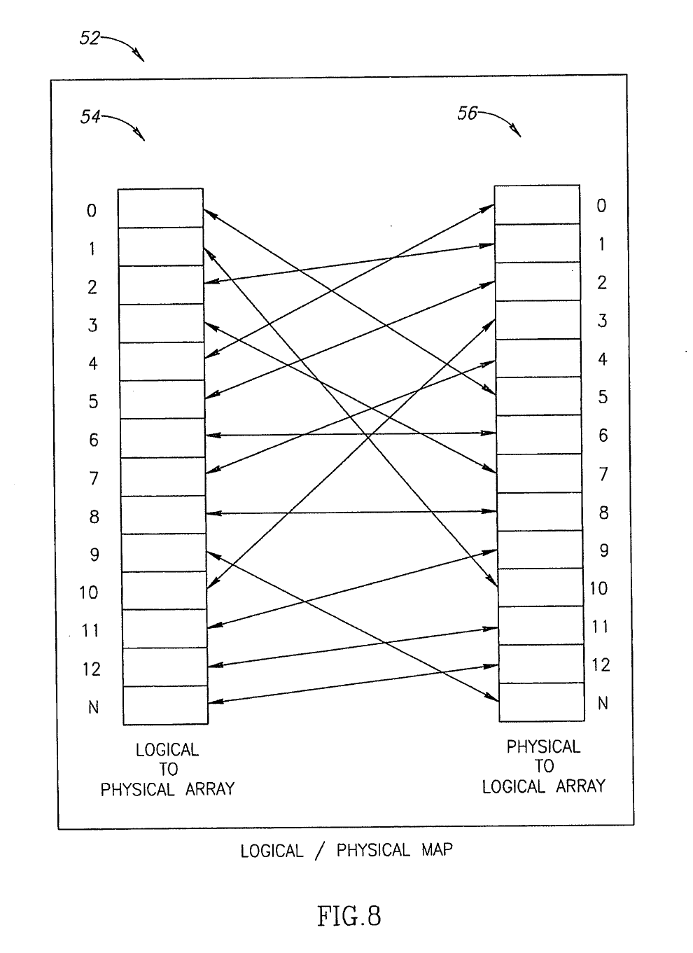

FIG. 8. shows an exemplary logical/physical map 32 of FIG. 3 in greater detail. Logical/physical map 32 is comprised of a logical to physical array 54 as well as a physical to logical array 56. In an exemplary embodiment, logical to physical array 54 contains integers corresponding to the physical locations of erase sectors 20. Physical to logical array 56 contains integers which indicate for a given erase sector 20, what location it maps to in the logical address space.

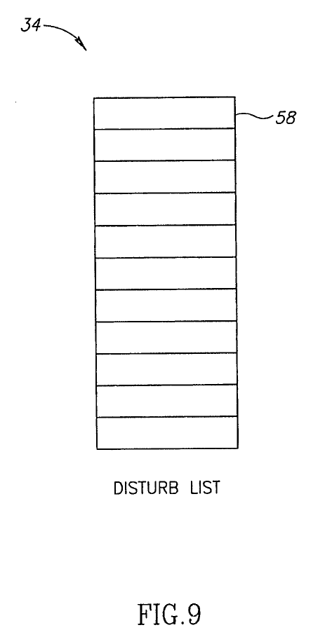

FIG. 9 shows a disturb list 34 of FIG. 3 in greater detail. Disturb list entries 58 contains a variable number of entries which contain the physical address of an erase sector 20 which requires maintenance due to the fact that it has been disturbed too much. Disturb list entries 58 are added to disturb list 34 as erase sectors 20 exceed their various thresholds with respect to the number of disturb operations of various kinds that they can reasonably sustain.

The exemplary embodiments disclosed herein include processes for increasing the reliability and lifespan of flash memory device 4. To this end, several exemplary rules are set forth, which are implemented by the exemplary processes disclosed herein. One exemplary rule is that two consecutive logical addresses of logical to physical array 54 will not map to the same physical sector 18. This exemplary rule, given by way of example and not limitation, ensures that cycling will be evenly distributed over the entire flash memory array 16. If this rule is not enforced, then, various portions of flash memory array 16 will wear out faster than other portions.

Another exemplary, non-limiting rule calls for a maximum logical distance between erase sectors 20 which belong to the same disturb group. The disturb group includes all of the erase sectors 20 to which it is connected by either bit lines 24 or word lines 26. This rule is not absolute and is, in fact, hard to keep; it in most cases will be violated after some number of cycles. Another exemplary rule given by way of example and not limitation, is that at least one spare erase sector 20 must be maintained in each physical sector 18.

Variations of these rules will be evident to those of skill in the art. Adherence to these rules can improve product reliability significantly because they address a key problem regarding the wear suffered by flash memory device 4 as it is used and reused. Although there is obviously some performance penalty for the implementation of these rules, that penalty seems to be reasonable for typical flash memory devices.

There are many ways to implement operations that adhere to these rules as will be apparent to persons of skill in the art. The most important rule is to keep the disturb level below the disturb threshold. For example, the wear leveling threshold may be set to a very low number (e.g. less than 10), thereby guaranteeing no disturbs. Also a system can be implemented to count the disturbs in the flash device itself. The foregoing exemplary embodiments are given by way of example and not limitation.

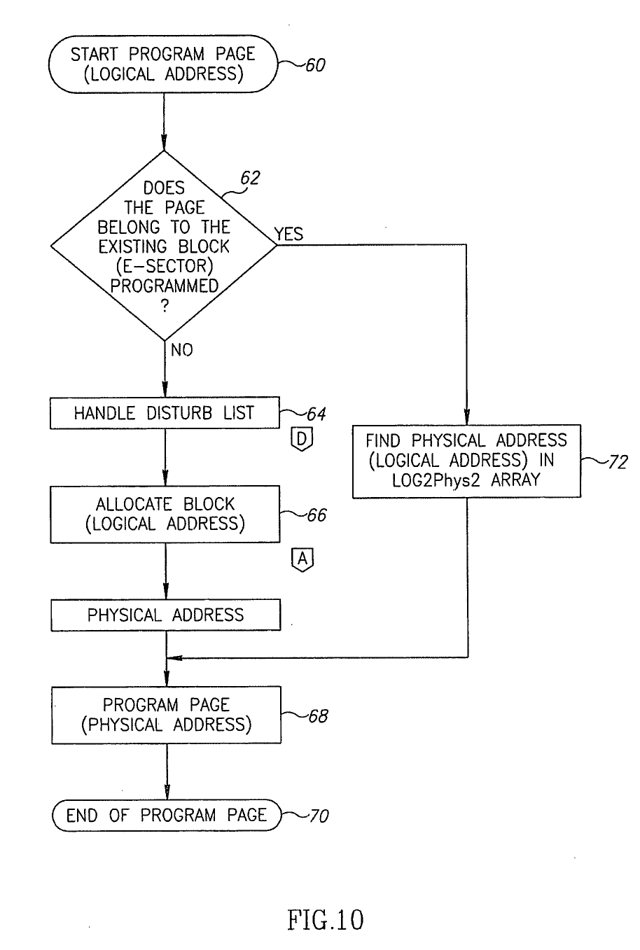

FIG. 10 describes an exemplary operation which is meant to embody the aforementioned rules. It is given as an exemplary, non-limiting embodiment. The operation starts in an operation 60 and continues with a decision operation 62. The purpose of the operation described in FIG. 10 is to program or write a page specified by a logical address within flash memory device 4. Operation 62 determines whether the page specified by the aforementioned logical address belongs to the existing erase sector 20 programmed. If it is determined that it does not, then, control passes to an operation 64 which handles a disturb list 34 of FIG. 3. Then, in an operation 66, a block is allocated for the given logical address. Then, in an operation 68, a physical address derived in operation 66 is used to indicate the specific page to be programmed. The page is programmed and, then, the operation terminates in an operation 70. If, in decision operation 62, it is determined that the page specified by the logical address does belong to the existing erase sector 20 programmed, control passes to an operation 72 which finds the physical address corresponding to the logical address that has been previously allocated. Once the physical address has been obtained, control passes to operation 68, which programs the page corresponding to the physical address obtained in block 72. The operation is then terminated in operation 70.

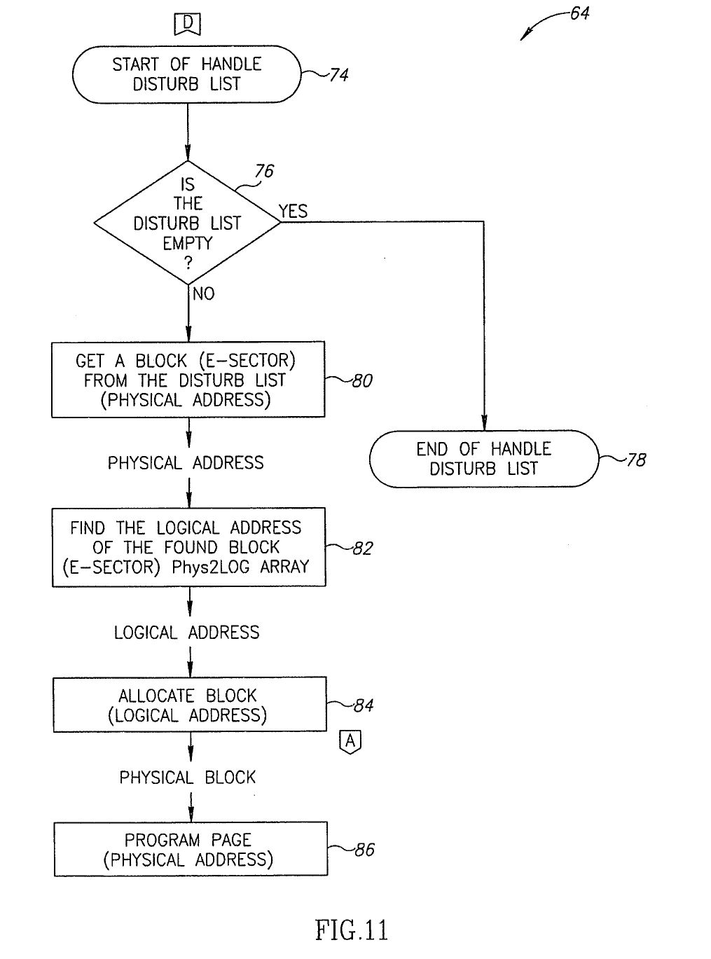

FIG. 11 shows operation 64 of FIG. 10 in greater detail. The operation begins with an operation 74 and continues with a decision operation 76 which determines whether or not the disturb list is empty, i.e., it does not contain any entries. If it is determined that the disturb list does not contain any entries, then, the operation terminates in an operation 78. If it is determined that the disturb list is not empty, then a disturb list entry 58 is obtained from disturb list 34. This results in a physical address. This operation 80 also removes the disturb list entry 58 from disturb list 34. The physical address obtained in operation 80 is then processed by an operation 82 which finds the logical address of the erase sector 20 by accessing physical to logical array 56. The resultant logical address is used in an operation 84 which allocates a block for this logical address. This operation results in a physical block address which is passed to an operation 86 which programs the page corresponding to the physical address. Control then passes back to decision operation 76 and continues iterating until the disturb list is empty. This operation can have many variations and is given by way of example and not limitation.

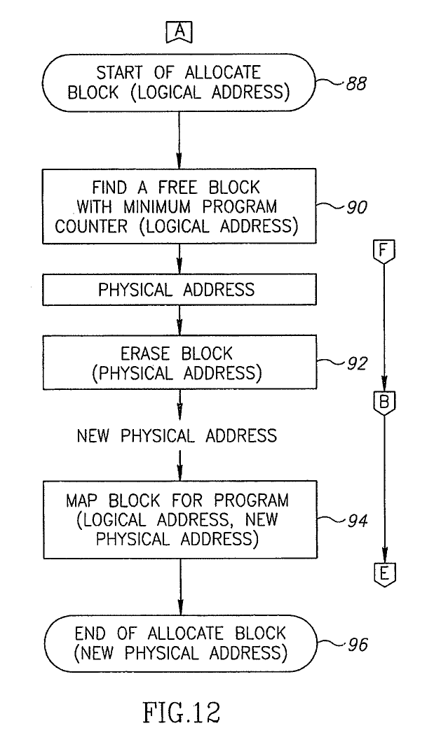

FIG. 12 shows operation 66 of FIG. 10 in greater detail. The operation begins in an operation 88 and continues with an operation 90 which finds a free block with a program counter that is equal to MIN program counter 36. The physical address of the block with the MIN program counter is passed to an operation 92 which erases the corresponding erase sector 20. The erase operation 92 produces a new physical address which is passed to an operation 94 which maps the block with respect to logical to physical array 54 and physical to logical array 56. The operation then terminates in an operation 96.

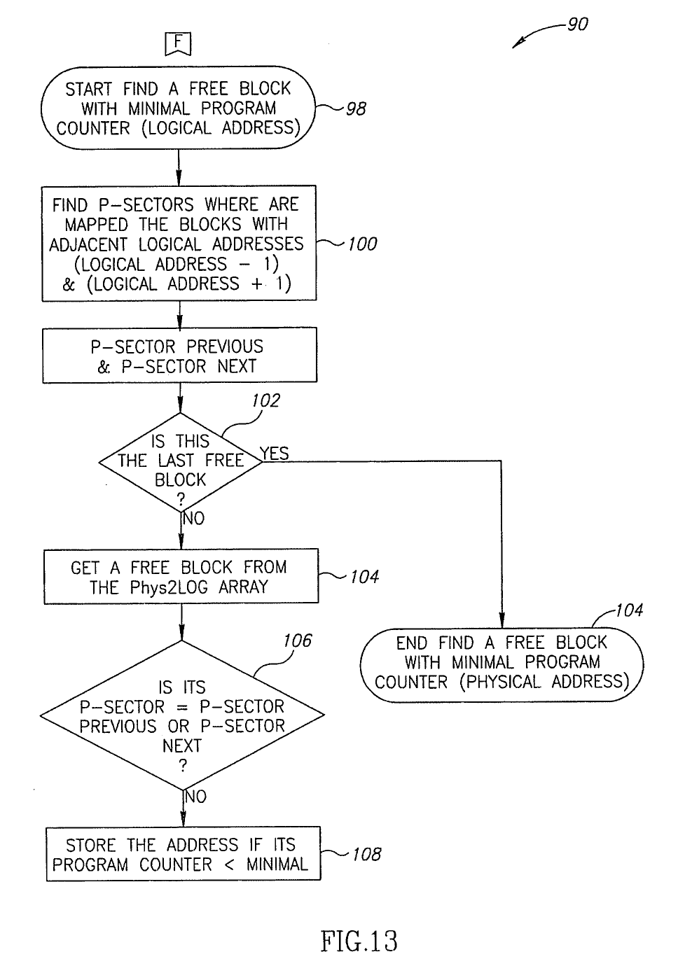

FIG. 13 shows operation 90 of FIG. 12 in greater detail. The operation begins with an operation 98 and continues with an operation 100 which finds physical sectors 18 containing the erase sectors 20 which are logically adjacent to the erase sector 20 corresponding to a logical address passed in, in operation 98. Once these two physical sector logical addresses are obtained, control passes to a decision operation 102 which determines whether or not this is the last free block. If it is determined in operation 102 that this is the last free block, control passes to an operation 104 which terminates the operation. If, on the other hand, it is determined in operation 102 that this is not the last free block, then, a free block is obtained from physical to logical array 56 in an operation 104. Control then passes to a decision operation 106, which determines whether or not its physical sector is equal to either of the physical sectors which are adjacent to this one. If it is determined that it is, then, control passes to operation 102 previously described. If, in operation 106, it is determined that it is not equal, then, control passes to an operation 108 which stores the address if its program counter is minimal. Control then passes back to decision 102.

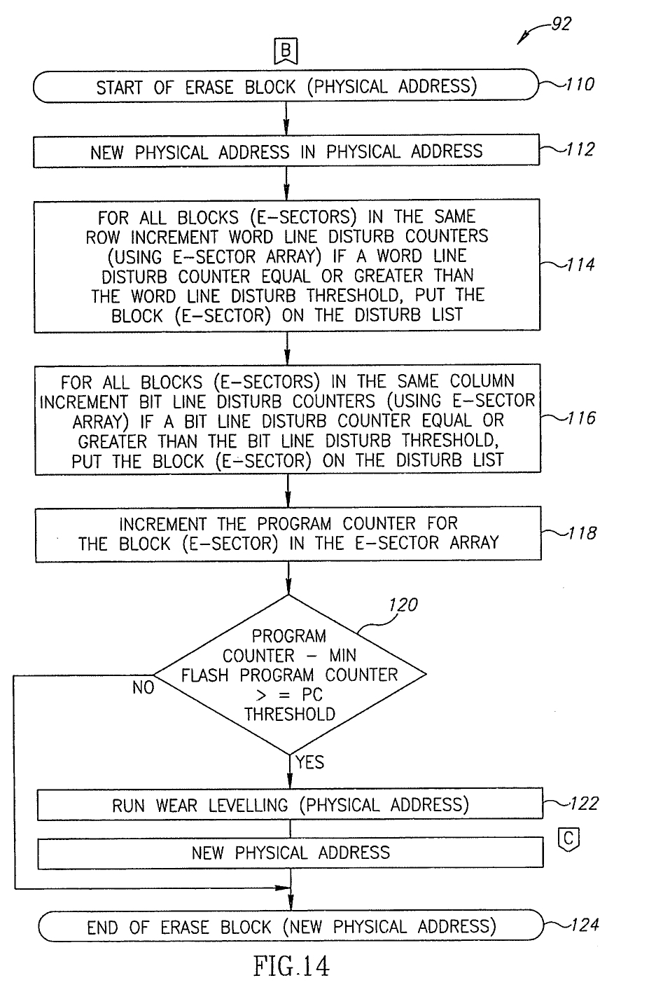

FIG. 14 describes an operation 92 of FIG. 12 in greater detail. The operation begins with an operation 110 wherein a physical address is passed in. Then, in an operation 112, the new physical address is set to be equal to the physical address which was passed in, in operation 110. Then, in an operation 114, the word line disturb counter 50 is incremented for each erase sector 20 connected to this erase sector 20 via word line 26. This is done using E-sector array 40.

During this operation, if a word line disturb counter 50 exceeds the word line disturb threshold, then, the physical address of the corresponding erase sector 20 is placed on the disturb list as a disturb list entry. Then, operation 116 increments the bit line disturb counters 48 in E-sector array 40 which are connected via bit lines 24 to the erase sector 20 that is being erased. If, during this operation, it is found that one of the erase sectors 20 has a corresponding bit line disturb counter 48 that has exceeded the bit line disturb threshold, then, the physical address of that erase sector 20 is placed on the disturb list 34 as a disturb list entry 58. Then, in an operation 118, the program counter for the erase sector 20 being erased is incremented in the E-sector array 40. Then, in a decision operation 120, it is determined whether or not the program counter for the erase sector 20 minus the minimum flash program counter is greater than or equal to the program counter threshold. If so, control passes to an operation 122. If, on the other hand, it is not greater than or equal to the program counter threshold, then, control passes to an operation 124, which terminates the operation. Operation 122 runs a wear leveling operation for the erase sector 20 that is being erased. Then, control passes to operation 124 which terminates the operation.

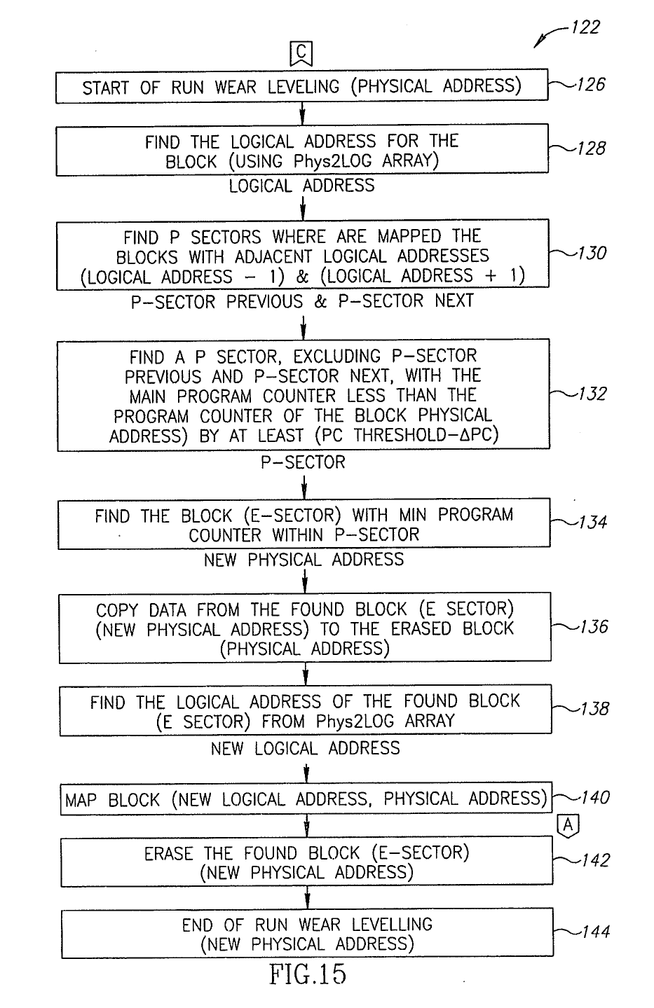

FIG. 15 describes operation 122 of FIG. 14 in greater detail. The operation begins with an operation 126 which starts the operation by receiving a physical address. Then, in an operation 128, the logical address for the block is obtained using the physical to logical array 56 which results in a logical address being obtained. Then, in an operation 130, the physical sectors containing the erase sectors 20 which are logically adjacent to the logical address obtained in operation 128 are found. Then, in an operation 132, a physical sector 18 is found which meets certain conditions. The physical sector is not the same as the physical sectors 18 found in operation 130. Also, the MIN program counter of this physical sector 18 must be less than the program counter of the block specified by the physical address by at least the program counter threshold minus Delta program counter. Control passes to operation 134 which take the physical sector 18 found in operation 132 and finds the erase sector 20 with the MIN program counter within this physical sector. That is, it finds the erase sector that is among the newest within the physical sector.

This results in a physical address of an erase sector which is, then, used in operation 136 to copy the data from the found erase sector 20 corresponding to the physical address obtained in operation 134 corresponding to the erase sector 20 specified by the physical address of operation 126. Operation 138 finds the logical address of the found erase sector 20 using the physical to logical array 56 which results in a new logical address. An operation 140 maps the erase sector 20 with respect to its logical and physical addresses. Then, in an operation 142, erases the found erase sector 20 corresponding to the new physical address. The operation then terminates in an operation 144.

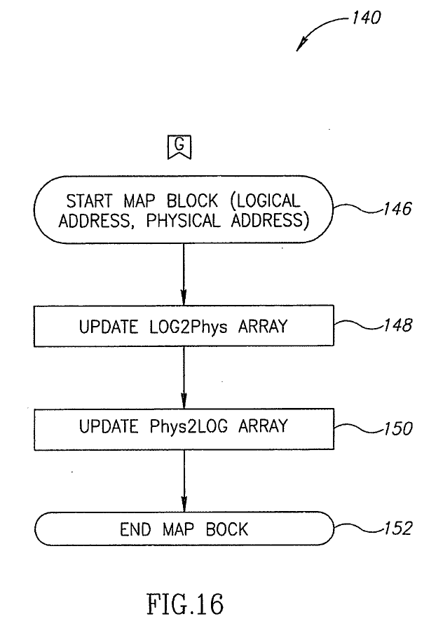

FIG. 16 shows operation 140 of FIG. 15 in greater detail. The operation begins with an operation 146, which receives as input parameters a logical address and a physical address. Then, in an operation 148, the logical to physical array 54 is updated. Then, in an operation 150, the physical to logical array 56 is updated. The operation then terminates in an operation 152.

Although various embodiments have been described using specific terms and devices, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of various other embodiments may be interchanged either in whole or in part. It is therefore intended that the claims be interpreted in accordance with the true spirit and scope of the invention without limitation or estoppel.

What is claimed is:

1-24. (canceled)

25. A non-volatile memory device comprising:
a controller adapted to select a destination memory sector to which to write data based on a wear leveling algorithm.

26. The device according to claim 1, further comprising count logic adapted to detect usage of the memory sectors and to update a usage count accordingly.

27. The device according to claim 1, wherein said controller comprises disturb logic adapted to determine if a memory sector has been subjected to conditions which would imply excessive wear and to update a disturb list accordingly.

28. The device according to claim 3, wherein said controller is adapted to perform a wear balancing operation.

29. The device according to claim 4, wherein said wear balancing operation includes moving data from memory sectors listed in the disturb list.

30. The device according to claim 4, wherein said controller is adapted to update a logical/physical mapping table corresponding to memory sector moves performed during the wear balancing operation.

31. The device according to claim 4, wherein said controller includes minimum program counter logic adapted to determine a least used memory sector.

32. The device according to claim 7, further comprising a minimum program counter adapted to store an address of said least used memory sector.

33. The device according to claim 8, wherein said controller is adapted to use data from said minimum program counter during a wear balancing operation.

34. The device according to claim 8, wherein said controller is adapted to use said minimum program counter in selecting a destination memory sector to which data from a worn sector is to be copied.

35. A method of operating a non-volatile memory device, said method comprising: selecting a destination memory sector to which to write data based on a wear leveling algorithm.

36. The method according to claim 11, further comprising detecting usage of the memory sectors and updating a usage count accordingly.

37. The method according to claim 11, further comprising determining if a memory sector has been subjected to conditions which would imply excessive wear and updating a disturb list accordingly.

38. The method according to claim 13, further comprising performing a wear balancing operation.

39. The method according to claim 14, wherein said wear balancing operation includes moving data from memory sectors listed in the disturb list.

40. The method according to claim 14, further comprising updating a logical/physical mapping table corresponding to memory sector moves performed during the wear balancing operation.

41. The method according to claim 14, further comprising determining a least used memory sector.

42. The method according to claim 17, further comprising storing an address of said least used memory sector.

43. The method according to claim 18, further comprising using data from said minimum program counter during a wear balancing operation.

44. The method according to claim 18, further comprising using said minimum program counter in selecting a destination memory sector to which data from a worn sector is to be copied.
